(19) United States
(12) Patent Application Publication
(10) Pub. No.: US 2022/0347885 A1
(43) Pub. Date: Nov. 3, 2022

(54) WATER COLLECTION ASSEMBLY FOR TILE SAW

(71) Applicant: REXON INDUSTRIAL CORP., LTD., Taichung (TW)

(72) Inventor: Yue-Yi LIN, Taichung (TW)

(21) Appl. No.: 17/735,644

(22) Filed: May 3, 2022

(30) Foreign Application Priority Data
May 3, 2021 (TW) 110115935

(51) Int. Cl. B28D 7/02

(52) U.S. Cl. CPC B28D 7/02

(57) ABSTRACT

A water collection assembly for a saw blade of tile saw includes, a collecting tray and a wiper blade. The collecting tray includes a collecting tank. The wiper blade is disposed on the collecting tray and is located in the collecting tank. The wiper blade has a notch defined therein which accommodates a part of the saw blade without interfering with the saw blade. Therefore, during the cutting process of the saw blade, the excess water driven by the high-speed rotating saw blade will be scraped off by the wiper blade, and the water will be guided by the wiper blade to the collecting tank. Accordingly, water splashing can be reduced during cutting process.

### BACKGROUND OF THE INVENTION

### 1. Technical Field

The present invention is related to a tile cutter, and in particular, to a water collection assembly for a tile saw.

### 2. Description of Related Art

Since tiles are materials with crisp and hard characteristics, during tile cutting, conventional cutting tools cannot be used, and tile cutters designed exclusively for tile cutting must be used to perform cutting. During the cutting process, water is often sprayed onto tiles timely, and the purpose of the water spray is to cool the temperature of the saw and to wet the dust and powder to prevent arbitrary scattering of dust and powder in the air, thereby protecting operators from inhaling excessive dust and powder that may cause discomfort and pose a health hazard.

In the known technology, the saw blade at the rear is typically installed with a water shield in order to reduce waster splash with the water shield during the cutting process; however, the actual water shielding effect of the water shield is found to be poor, and the water shield cannot be retracted and stored when it is not in use. Accordingly, the problem of space occupation of the water shield occurs.

### BRIEF SUMMARY OF THE INVENTION

The primary objective of the present invention is to provide a water collection assembly for a tile saw, having a simple structure and capable of preventing water splash and overcoming the difficulty of device storage.

To achieve the aforementioned primary objective, the water collection assembly of the present invention comprises a collecting tray and at least one wiper blade. The collecting tray is arranged underneath a saw blade and includes a collecting tank. The wiper blade is arranged at the collecting tray and located in the collecting tray. The wiper blade includes a notch. A portion of the saw blade penetrates into the notch without contacting with the wiper blade in order to prevent interference.

According to the above, it can be understood that during the cutting process of the saw blade, the water driven by the saw blade rotating at high speed is scrapped off by the wiper blade when the water reaches the wiper blade and is further guided by the wiper blade to the collecting tank. As a result, it is able to reduce water splash without the need to install a water shield at the rear of the saw blade as used by the known technology, such that the problem of storage difficulty can also be overcome.

Preferably, the collecting tray includes a base wall, a front wall, a rear wall, a left wall and a right wall. The front wall, the rear wall, the left wall and the right wall are connected to a perimeter of the base wall, arranged so that the base wall, the front wall, the rear wall, the left wall and the right wall surround and form the collecting tank. The wiper blade is arranged at the inner surface of the right wall.

Preferably, a bottom end of the wiper blade is secured to the base wall, a right side of the wiper blade is secured to the right wall, the notch extends linearly downward from a top end of the wiper blade and is spaced apart from the base wall by a predefined distance.

Preferably, the wiper blade integrally extends rearward from the right wall to obliquely protrude outward, and also intersects with a plane of the saw blade obliquely, allowing the water reaching the wiper blade to be guided by the wiper blade into the collecting tank.

Preferably, there are two wiper blades arranged parallel to each other and spaced apart from each other at a front end and a rear end one after another. In addition, the notch located at the wiper blade at the rear end cooperates with the shape of the saw blade such that it has a relatively shorter length, such that an appropriate gap can be maintained between the saw blade and the bottom end of the two notches.

The detailed structure, features, assembly or method of use of the water collection assembly for a tile saw of the present invention are further described in the following embodiments of the present invention. Nevertheless, a person with ordinary skilled in the art in the technical field of the present invention shall understand that the detailed description and specified embodiments of the present invention are provided to illustrate the present invention only such that they shall not be used to limit the scope of the claims of the present invention.

### BRIEF DESCRIPTION OF THE SEVERAL VIEWS OF THE DRAWINGS

FIG. 1 is a perspective view of a tile saw with the water collection assembly of the present invention;

FIG. 2 is a perspective view of the water collection assembly of the present invention;

FIG. 3 is a longitudinal cross sectional view of the water collection assembly for a tile saw of the present invention;

FIG. 4 is a partial lateral cross sectional view of the water collection assembly for a tile saw of the present invention during it use; and

FIG. 5 is a partial top view of the water collection assembly of the present invention.

### DETAILED DESCRIPTION OF THE INVENTION

The Applicant emphasizes that for the content of this specification, including the embodiments and the claims described in the following, relevant directional terms shall refer to the directions shown in the drawings in principle. In addition, for the embodiments and drawings described in the following, identical component signs refer to identical or similar components or structural features.

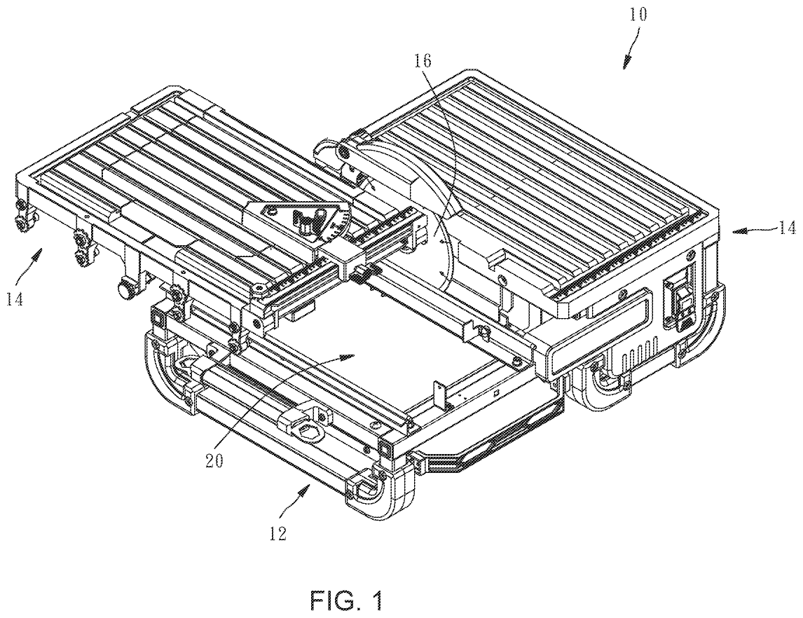

Please refer to FIG. 1. As shown in FIG. 1, a tile saw 10 comprises a base 12, two working platforms 14 and a saw blade 16. The two working platforms 14 are slidably arranged on top of the base 12 and provided to place a tile (not shown in the drawings) thereon for cutting. The saw blade 16 is arranged between the two working platforms 14 and can be driven by a power source (such as motor, not shown in the drawings) in order to perform cutting of the tile placed on the two working platforms 14. Since the tile saw 10 is not the main scope of the present invention, its detailed structure and operation process are omitted here.

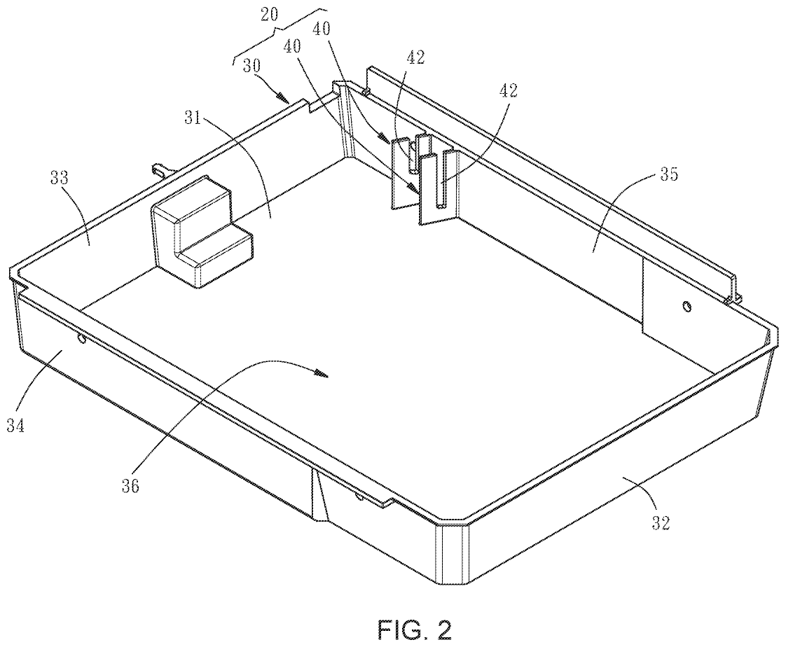

As shown in FIG. 2, the water collection assembly 20 is an integral structure, comprising a collecting tray 30 and two wiper blades 40 (while two wiper blades are shown in the embodiment, only one is required in practice).

The collecting tray 30 is arranged on the base 12 and located underneath the saw blade 16. The collecting tray 30 includes a base wall 31, a front wall 32, a rear wall 33, a left wall 34 and a right wall 35. The front wall 32, the rear wall 33, the left wall 34 and the right wall 35 are integrally connected to a perimeter of the base wall 31, and arranged so that the base wall 31, the front wall 32, the rear wall 33, the left wall 34 and the right wall 35 jointly surround and form a collecting tank 36. The collecting tank 36 is used to collect water sprayed onto the tile during the cutting process.

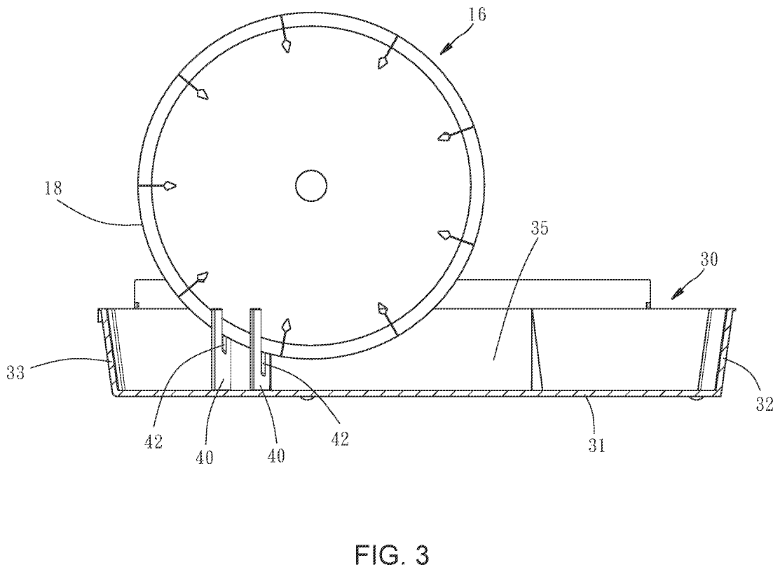

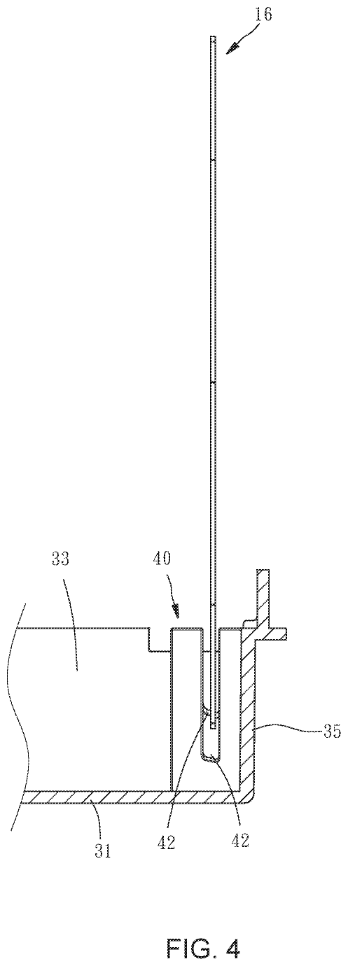

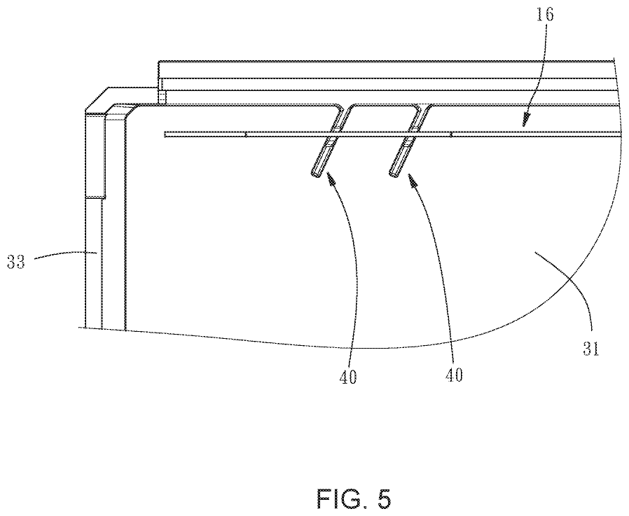

Two wiper blades 40 are arranged parallel to each other and spaced apart from each other at a forward position and a rear position, respectively, inside the collecting tank 36, one after another. The bottom ends of the two wiper blades 40 are integrally connected to the base wall 31. The right sides of the two wiper blades 40 are integrally connected to the right wall 35. In terms of the height, the two wiper blades 40 are not limited to being aligned with the right wall or slightly lower than the right wall 35 but preferably do not exceed the right wall 35 in height. As shown in FIG. 2 to FIG. 5 (wherein to facilitate the illustration and explanation, the saw blade 16 is shown while other components of the tile saw 10 are omitted), each wiper blade 40 includes a notch 42, and the notch 42 extends linearly downward from a top end of the wiper blade 40 and terminates a distance above the base wall 31. The notches 42 of the two wiper blades 40 accommodate a portion of the saw blade 16 without contacting with the saw blade 16, such that the two wiper blades 40 and the saw blade 16 do not interfere with each other. In addition, the notches 42 of the two wiper blades 40 at the forward and rear positions have different lengths. To be more specific, the notch 42 of the wiper blade 40 at the rear end cooperates with the shape of the saw blade 16 such that it has a relatively shorter length, allowing an appropriate gap to be maintained at the perimeter 18 of the saw blade 16 and the bottom ends of the two notches 42. Furthermore, as shown in FIG. 5, the two wiper blades 40 integrally extends rearward from the right wall 35 to obliquely protrude outward and also intersects with the saw blade 16 obliquely, in order to achieve the water flow guiding effect.

According to the above, it can be understood that during the cutting process of the saw blade 16, most of the water sprayed onto the tile is driven by the high-speed rotating saw blade 16 to the two wiper blades 40, following which the water is scrapped off by the two wiper blades 40 when it passes through the two notches 42. At this time, the inclined arrangement of the two wiper blades 40 is utilized to allow the water to flow rearward along the inclined surface of the two wiper blades 40 and to be guided into the collecting tank 36. Accordingly, water splash can be reduced, such that there is no need to install a water shield used by the know technology at the rear of the saw blade 16. Furthermore, since the collecting tank 30 and the two wiper blades 40 form an integral structure, the problem of storage difficulty can be overcome.

What is claimed is:

1. A water collection assembly for a tile saw, the tile saw comprising a saw blade, the water collection assembly comprising:
a collecting tray arranged underneath the saw blade and having a collecting tank; and
at least one wiper blade arranged at the collecting tray and located in the collecting tray; the at least one wiper blade having a notch for accommodating a portion of the saw blade without contacting with the saw blade.

2. The water collection assembly for a tile saw according to claim 1, wherein: the collecting tray includes a base wall, a front wall, a rear wall, a left wall and a right wall; the front wall, the rear wall, the left wall and the right wall are connected to a perimeter of the base wall and arranged such that the base wall, the front wall, the rear wall, the left wall and the right wall jointly surround and form the collecting tank; and the at least one wiper blade is secured to the right wall.

3. The water collection assembly for a tile saw according to claim 2, wherein a bottom end of the at least one wiper blade is secured to the base wall, a right side of the at least one wiper blade is secured to the right wall, the notch extends linearly downward from a top end of the at least one wiper blade and terminates a predefined distance above the base wall.

4. The water collection assembly for a tile saw according to claim 3, wherein the at least one wiper blade extends rearward from the right wall to obliquely protrude outward.

5. The water collection assembly for a tile saw according to claim 4, wherein the at least one wiper blade intersects with the saw blade obliquely.

6. The water collection assembly for a tile saw according to claim 1, comprising two wiper blades, and the two wiper blades are arranged parallel to each other and spaced apart from each other at a forward position and a rear position, respectively, one after another.

7. The water collection assembly for a tile saw according to claim 6, wherein an accommodating length of the wiper blade at the rear position is smaller than an accommodating length of the wiper blade at the forward position.
